(19) United States
(12) Patent Application Publication
(10) Pub. No.: US 2025/0021993 A1
(43) Pub. Date: Jan. 16, 2025

(54) SYSTEM AND METHOD FOR USING A NON-FUNGIBLE TOKEN TO OPTIMIZE A PRODUCT LIFE CYCLE

(71) Applicant: CHRISTMAS GERARD HOLDINGS, LLC, DENVER, CO (US)

(72) Inventor: CHRIS CHRISTMAS, DENVER, CO (US)

(21) Appl. No.: 18/773,215

(22) Filed: Jul. 15, 2024

Related U.S. Application Data
(60) Provisional application No. 63/513,400, filed on Jul. 13, 2023.

(51) Int. Cl. G06Q 30/018; G06Q 20/38; H04L 9/00

(52) U.S. Cl. CPC G06Q 30/018; G06Q 20/389; H04L 9/50; G06Q 2220/10

(57) ABSTRACT

A method for tracking a product using non-fungible token, includes receiving a first blockchain associated with a first component product of a first supplier accessed through an encrypted cyber label; receiving a first non-fungible token operatively linked with the first component product and the first blockchain; receiving a second blockchain associated with a second component product of a second supplier accessed through a second encrypted cyber label; receiving a second non-fungible token operatively linked with the second component and first the first blockchain; and generating a third blockchain operatively linked to a product manufactured based on at least the first component product and the second component product accessed through a third encrypted cyber label, the third blockchain including the first blockchain and the second blockchain, and a non-fungible token associated with the third blockchain, the non-fungible token having an encrypted private key which comprises at least a portion of the third blockchain.

### CROSS REFERENCE TO RELATED APPLICATIONS

This U.S. Non-Provisional Patent application claims the benefit of and priority to U.S. Provisional Patent Application Ser. No. 63/513,400, filed on Jul. 13, 2023 titled “A System And Method For Using A Non-Fungible Token To Optimize A Product Life Cycle,” the entire disclosure of which is hereby incorporated by reference.

### BACKGROUND

Blockchain, although relatively new, is known for its use with documenting a history of an item or transaction. Blockchain verifies the transaction and history ownership of bitcoin. It is known to be used to verify the authenticity of documents such as a deed for land. However, even with the advent of blockchain there is no simple way for an owner of a product to confirm the status of a product; where it is in the manufacturing or commercial process. Furthermore, there is no incentive to utilize the more reliable blockchain technology for tracking the status of the good as compared to computerized “paper” records.

Additionally, undertaking a new product launch includes inherent risk. Furthermore, it requires capital. In the prior art, the risk was borne by the manufacturer/creator of the good. Additionally, launch of a durable good product requires capital. Because of the risk involved a manufacturer would turn to a bank for a loan, or issue equity ownership in the enterprise, both put the entire entity, not just the durable good up as collateral for the cash infusion.

### SUMMARY

An aspect of the disclosed embodiments includes a system for tracking a product includes a first supplier. The first supplier provides a first component product and a first blockchain associated with the first component product accessed through an encrypted cyber label; and a first non-fungible token operatively linked with the first supplied component and the first blockchain. A second supplier provides a second component product; a second blockchain associated with the second component product accessed through a second encrypted cyber label; a second non-fungible token operatively linked with the second component. A manufacturer creates the product from at least the first supplied component product and the second component product; and creates a third blockchain operatively linked to the product, the third blockchain including the first blockchain and the second blockchain, and a third non-fungible token associated with the third blockchain.

In some embodiments, the system includes a tracker for recording each sale of the product and information associated with the sale. The tracker creates an updated NFT as a function of at least the third blockchain, the third non-fungible token and the information associated with the sale. The system may also include a unique source providing a unique product, the non-fungible token exhibiting the unique product.

In some embodiments, the system creates the non-fungible token which exhibits the unique product, furthermore, the tracker receives funds from the sale of the product, and distributes the funds among tat at least one of the manufacturer, the unique source and a seller.

In some embodiments, a second class of blockchain based toke, fungible or not, is issued by the manufacturer ahead of the durable good creation. The second class of blockchain is associated with a smart contract linked to the token and the durable good. The smart contract has at least one clause in which payment is made to the owner of the second class of token, up on each purchase of the product.

In some embodiments, a manufacturer issues their own blockchain based fungible tokens as branded crypto currency. A manufactured article such as a team jersey, includes a cyber label thereon associated with a post-production NFT from the manufacturer. In accordance with a smart contract associated with the NFT, the product is purchased with manufacturer branded crypto currency.

To promote crypto liquidity a third party may be required to exchange one form of cryptocurrency for another. In some embodiments, a trustee or bank acts a crypto-exchange by exchanging branded cryptocurrency as a function for the value of the underlying intellectual property.

These and other advantages and features will become more apparent from the following description taken in conjunction with the drawings.

### BRIEF DESCRIPTION OF THE DRAWINGS

The disclosure is best understood from the following detailed description when read in conjunction with the accompanying drawings. It is emphasized that, according to common practice, the various features of the drawings are not to-scale. On the contrary, the dimensions of the various features are arbitrarily expanded or reduced for clarity.

FIG. 1A is a plan view of a watch constructed according to the principles of the present disclosure.

FIG. 1B is a plan view of a private key according to the principles of the present disclosure

FIG. 2 is a block diagram of a system according to the principles of the present disclosure.

FIG. 3 is a flowchart of the manufacturing method according to the principles of the present disclosure.

FIG. 4 is a flowchart of the creating a watermark and associating the watermark with the NFT during the manufacturing process according to the principles of the present disclosure.

FIG. 5 is a flowchart for associating an NFT with the lifecycle of production according to the principles of the present disclosure.

FIG. 6 is a flowchart of the method for tracking of the lifecycle of the product utilizing the NFT according to the principles of the present disclosure.

FIG. 7 is a flowchart of the method for producing and utilizing a second class of token associated with the durable good according to the principles of the present disclosure.

FIG. 8 is an exploded view of a product manufactured according to the principles of the present disclosure.

FIG. 9 is an operational diagram of an environment for creating and using an NFT according to the principles of the present disclosure.

FIG. 10 is a flow chart of the use of an NFT according to the principles of the present disclosure.

FIG. 11 generally illustrates a computing device according to the principles of the present disclosure.

### DETAILED DESCRIPTION

The following discussion is directed to various embodiments of the disclosure. Although one or more of these embodiments may be preferred, the embodiments disclosed should not be interpreted, or otherwise used, as limiting the scope of the disclosure, including the claims. In addition, one skilled in the art will understand that the following description has broad application, and the discussion of any embodiment is meant only to be exemplary of that embodiment, and not intended to intimate that the scope of the disclosure, including the claims, is limited to that embodiment.

The systems and methods described herein may be directed to a structure and method for utilizing blockchain technology and more particularly for using encrypted information in the form of a cyber label linked to a non-fungible token (“NFT”) to track product quality control, manage life cycle events relative to the product and track changes in product value over the product lifetime.

In some embodiments, a structure and methodology making use of the unique cyber label linked to NFTs, and the use of blockchain based tokens (fungible or not) or to raise capital while only putting the token or underlying good at risk, to overcome the shortcomings of the prior art is provided.

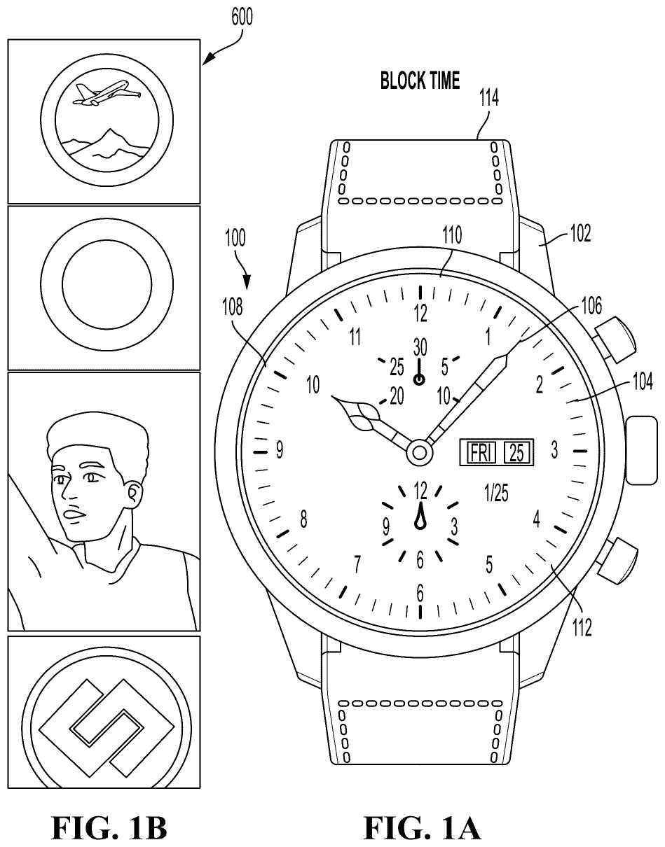

Reference is first made to FIG. 1A in which a watch 100, known in the art includes a casing 102, a face 104 supported in the casing and an hour hand 106, a minute hand 108 and a second hand 110 operatively mounted on the face 104. As known in the art, a movement (not shown) is mounted within the casing 102 and is operatively coupled to each of the hour hand 106, the minute hand 108 and the second hand 110 for movement thereof. Straps 114, leather according to some embodiments, are affixed to casing 102.

A watermark 112 is dispose don watch 100 at a position which can be easily viewed by a person and/or read by a machine. In this non-limiting example, the watermark is on the face 104 of watch 100 and is an artwork or logo. It is well within the scope of the invention that the watermark take the form of a celebrity likeness such as an athlete's initials, face, or uniform.

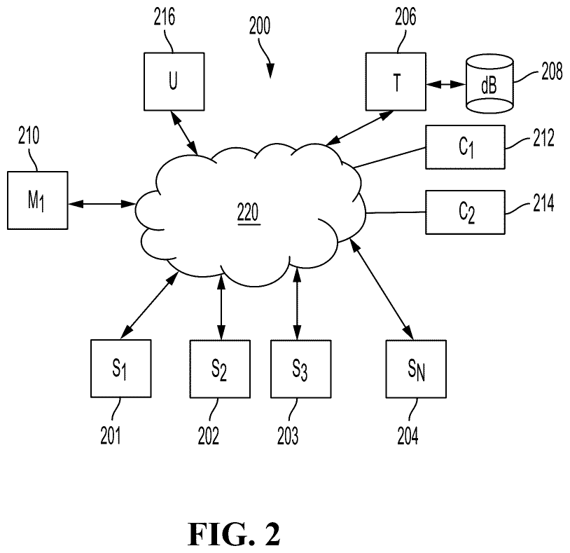

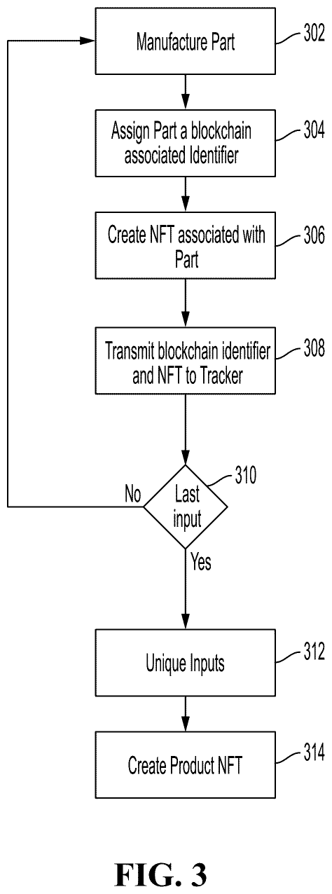

Reference is now also made to FIGS. 2 and 3 in which the ecosystem and methodology for assembling a watch in accordance with the invention is provided. A tracker 206 for tracking information associated with each product, as will be described below, is associated with a database 208. Database 208 may be dedicated to tracker 206 or be in the cloud 220, with which tracker 206 communicates so that database 208 communicates with two or more trackers. Tracker 206 tracks the product constituent parts used by a manufacturer M₁ 210 supplied by one or more suppliers S_{N} and a unique source U 216 to create watch 100. Tracker 206 may record a host of information associated with watch 100 such as identity of each source S, date and time manufactured and shipped, sale price, or even non manufacture associated data such as carbon footprint any contractual restrictions on use of the watch as a result of a smart contract associated with a specific supplied part.

Following the watch example, supplier S₁ 201 may supply the casing 102, supplier S₂ 202 supplies the movement, supplier S₃ 203 supplies the hands 106, 108, 110, and supplier S_{N} 204 supplies the face 104. Each of supplier 201, 202, 203, 204 communicate with manufacturer M₁ 210 through could 220. Lastly, the unique source U 216, such as an athlete or an artist, being the creator of a unique product may contribute a likeness to be incorporated into watch 100. By way of non-limiting example, a likeness may include a name, a signature, a photo, artwork, or a personal logo, associated with the originator of the likeness.

As seen from FIG. 3, in a step 302 a part such as the casing 102 is manufactured by casing supplier S₁ 202. This casing 102 is assigned a unique identifier, in a step 304, which is formed as a blockchain and stored in cloud 200 at tracker T 206. The unique identifier may be associated with historical information regarding the casing 102, such as the identity of the manufacturer, the date and time of manufacture or the like. Each blockchain identifier is unique and follows only that casing 102. The unique identifier is affixed to the watch case in the form of a cyber label as an encrypted machine readable code. Cyber label as used herein means a machine readable encrypted watermark created by system 200 as described below, placed on a physical item, and tied to both the transactional blockchain associated with the item and an NFT associated with the item as discussed below.

In a step 306 an NFT is created by tracker T 206 of system 200, or in some embodiments, by supplier S₁ 201, and is also associated with the part, here watch case 102, and the blockchain identifier provided on watch case 102 as a cyber label. The NFT is a unique digital asset that represents ownership of the real world item; the watch case 102. More particularly, a private key is encrypted in the art of the NFT 600 (see FIG. 1B) which is registered on the blockchain associated with the part. The NFT and associated blockchain identifier is transmitted to tracker T 205 to be stored in database 208, such that the NFT and cyber label are linked.

In a step 310 it is determined whether this is the last input for watch 100. If it is not the last part to be assembled into watch 100, then the process returns to step 302 for the movement, face 104, hands 106, 108, 110 and straps 114 by way of example. If the last part to by processed is confirmed, then in a step 312 a unique input from creator 216 such as a likeness of a celebrity endorser, artwork, or company logo is added. This artwork can be a visible logo 112, brand, or the like, but can also be a machine readable component, such as a blockchain identifier or NFT. It should be noted that visible logos and associated cyber labels from a unique source U 216 may also be utilized for constituent parts, such as leather form Gucci, casings made from an alloy developed for NASA, or the like. In this case, the cyber label to be affixed to constituent supplied part readily confirms not just authenticity but the value add of the unique source.

In a step 314 a product NFT is created as function of the blockchain information discussed above. The product NFT is unique to each product in that it is created on a product by product basis and is linked to the supply chain blockchain identifiers discussed above, and may be the NFT associated with the supplied unique identifier discussed above, so that the NFT is an industrial NFT which acts not only as the home for the unique attribute (the likeness or the artwork) of the product, but also as the link to the previously stored blockchain information associated with each constituent part of watch 100; watch 100 as a whole. The NFT can be formed as part of watermark 112, or any other graphical indication, in machine readable form. Like the watermark, the NFT may include a name, a signature, a photo, artwork, or a personal logo, associated with the originator of the NFT. It may be the same as the watermark or have a different graphic expression entirely.

As a result, a system for tracking a product is provided which includes a first supplier. The first supplier provides a first component product and a first blockchain associated with the first component product. A link to the blockchain stored information is formed as a cyber label on the first component and, through the cyber label, the first blockchain. A second supplier provides a second component product. A second blockchain is associated with the second component product. A link to the blockchain stored information is formed as a second cyber label on the first component. A second non-fungible token is operatively linked with the second component. A manufacturer creates the product form at least the first supplied component and the second component product and creates a third blockchain operatively linked to the product, the third blockchain including the first blockchain and the second blockchain. A link to the third blockchain is formed as a cyber label disposed on the product and a third non-fungible token associated with the third blockchain.

A private key is encrypted in the art of the NFT which is registered on the blockchain for the finished product, and for each constituent part. As a result of the inventive process and structure, each watch 100 manufactured as above carries an NFT linked with a unique blockchain associated database. As a result, the NFT for an individual watch 100 can be used to verify the source of the watch 100 and its constituent parts as a function of the blockchain information associated with the NFT. A single NFT now does the job of several.

It follows that NFTs 600 created in accordance with the present invention can exhibit many visual features, including features which indicates where in the manufacture process the product currently exists. By way for example, each NFT from supplier S₁-S_{N} will each have their own different characteristics to indicate source, but all may be monochromatic or gray to indicate premanufacture status. Then once manufacturer M₁ 210 indicates to Tracker T 205 that manufacture is complete, Tracker 205 will create an FNT that is in color. This provides a simple optically viewable NFT to indicate not only that manufacture is complete, but that customer C₁ 212 is the first purchaser.

Additionally the NFT 600 will be unique to each watch 100 because the information stored with the NFT will be unique to each watch. It is also well within the scope of the invention to build the single NFT during the manufacturing process, by moving step 314 ahead of step 310 in the process, so that initially the single NFT would be the same as the NFT for casing 102. However, when the process incorporates placing the movement within the casing a new NFT incorporating information about the casing 102 and the movement would be created, until each of the steps is completed in the process. It is understood that it is also contemplated within the invention that the blockchain changes as a function of each of these steps, but he NFT may be able to exhibit a different color for the same image at each stage of manufacture so that reading the NFT causes a color to be displayed, giving a quick eyeball check on where the process is.

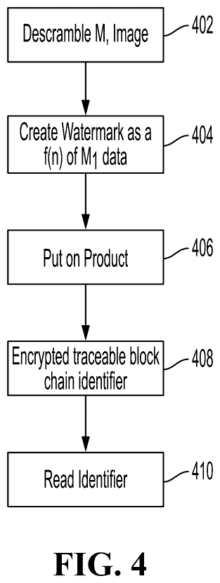

Reference is now made to FIG. 4 wherein the methodology for creating and processing watermark 112 is provided. As discussed above manufacturer M₁ 210 creates a watermark 112 upon completion of the manufacturing process. The visible watermark 112 and the underlying cyber label ties an NFT to a blockchain identifier as well as tying the NFT to information about the watch 100 upon which watermark 112 resides. However, as described above the associated NFT need not be static and can be used to store new information during different life cycle stages.

In accordance with the invention, as discussed above, in a step 402 manufacturer will descramble the information it has received from all of the parties involved in supplying the watch parts and subassembly thereof, including the input of the unique item from U 216 to be incorporated onto the watch as a visible component and as part of the NFT. In step 404, manufacturer M₁ 210 will create the water mark for the watch, in machine readable form as a cyber label, and visual if desired, as a function of this M₁ data. In step 406 the watermark 112 is applied to the product; watch 100.

In a step 408 the watermark 112 through the cyber label is associated with an encrypted traceable blockchain identifier. This serves as an authentication of the watch 100. As discussed above the identifier is also associated with all of the manufacturing data associated with the blockchain including any associated smart contract. When the cyber label of watermark 114 is read, all of the associated data may be accessed.

As can be seen from the above because each NFT and associated blockchain identifier is unique to each watch the information follows the watch 100 for its lifetime. As a result, when manufacturer M₁ 210 sells the watch to a customer C₁ 212 the date, place and price can be recorded and associated with the blockchain identifier. Intellectual property rights may be transferred by way of a smart contract associated with the blockchain underlying the cyber label.

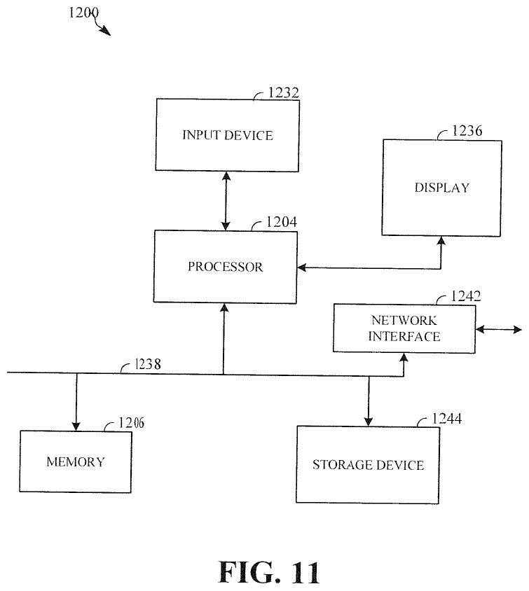

Additionally, as discussed below, if other characteristics, such as the winner of Wimbledon was wearing the watch the day customer C₁ 212 purchased the watch as a limited edition at Wimbledon, this fact is stored with eh associated blockchain as a self-contained authentication. As a result, the value of the watch may be increased. For the purposes of this discussion customer C₁ 212 and customer C₂ 214 are the devices, computer, tablet, or phone used by real world customers to participate with system 200 to display NFTs, and make the transactions discussed above and below. For example, C₁ 212 and C₂ 214 may comprise a computing device, such as a computing device 1200 as is generally illustrated in FIG. 11.

The computing device 1200 may include any suitable computing device including a mobile computing device (e.g., a smart phone, tablet, or other suitable mobile computing device), a laptop-computing device, a desktop computing device, or any other suitable computing device. The computing device 1200 may include a processor 1204 and a memory 1206. The processor 1204 may include any suitable processor, such as those described herein. Additionally, or alternatively, the computing device 1200 may include any suitable number of processors, in addition to or other than the processor 1204. The memory 1206 may comprise a single disk or a plurality of disks (e.g., hard drives), and includes a storage management module that manages one or more partitions within the memory 1206. In some embodiments, memory 1206 may include flash memory, semiconductor (solid state) memory or the like. The memory 1206 may include Random Access Memory (RAM), a Read-Only Memory (ROM), or a combination thereof. The memory 1206 may include instructions that, when executed by the processor 1204, cause the processor 104 to, at least, perform the functions associated with the systems and methods described herein.

The computing device 1200 may include a user input device 1232, as is generally illustrated in FIG. 11, which may be configured to receive input from a user of the computing device 1200 and to communicate signals representing the input received from the user to the processor 1204. For example, the user input device 1232 may include a button, keypad, dial, touch screen, audio input interface, visual/image capture input interface, input in the form of sensor data, etc.

The computing device 1200 may include a display 1236 that may be controlled by the processor 1204 to display information to a user. A data bus 1238 may be configured to facilitate data transfer between, at least, a storage device 1244 and the processor 1204. The computing device 1200 may also include a network interface 1242 configured to couple or connect the computing device 1200 to various other computing devices or network devices via a network connection, such as a wired or wireless connection, or other suitable connection. In some embodiments, the network interface 1242 includes a wireless transceiver.

The storage device 1244 may comprise a single disk or a plurality of disks (e.g., hard drives), one or more solid-state drives, one or more hybrid hard drives, and the like. The storage device 1244 may include a storage management module that manages one or more partitions within the storage device 1244. In some embodiments, storage device 1244 may include flash memory, semiconductor (solid state) memory or the like.

In some embodiments, successive sales can be recorded and traced as a blockchain transaction associated with the unique identifier and NFT. As a result, when the identifier is read in a step 410 anyone will be able to confirm the authenticity of the product down to its constituent parts, to confirming any claims about the product (bought at Wimbledon on a particular day); all serving to enhance the value of such limited edition products.

Conversely, the use of an encrypted traceable blockchain identifier, such as the cyber label and NFT lends itself to a verifiable audit trail. This not only protects the next downstream purchase C₂ 214 from forgeries, but prevents the use of blood diamonds, or sweatshop laborers. This is because the blockchain information stored in association with the NFT includes the manufacturing history as provided by suppliers S_{N}, ensuring not only authenticity, but prevents the hiding of objectionable practices to any particular buyer.

Lastly, utilizing the disclosed system and method, one can track any change in value for an item between a first consumer C₁ 212 and a second consumer C₂ 214. Second purchasers are now incentivized to record private sales with Tracker T 206 to demonstrate to later purchasers the authenticity of the product they are selling. In this way, when first consumer C₁ 212 sells watch 100 to second consumer C₂ 214, the sale becomes part of the blockchain associated with the product NFT. Additionally the time, date, and place of the sale can all be recorded and later authenticated along with the sales price. In this way, the value, particularly if watch 100 becomes a collectable, can be tracked over time. This process can be repeated until the item being tracked is destroyed or has no value.

Additionally, the use of an NFT in accordance with the invention gives the original creator of the NFT or underlying good a structure to share in the downstream income derived from their creation. In some embodiments, a smart contract of sale is associated with the first blockchain and associated NFT. The contract of sale requires in part that each downstream seller can only sell the product or NFT to a buyer willing to abide by the contract. The contract has a clause that 5% of each follow on sale be paid to the creator of the unique logo/likeness NFT, in our examples that would be either M₁ 210 and/or the creator of the unique content U 216; an artist, celebrity, venue or the like. The system and method even facilitates payment of a portion of the sale to previous owners.

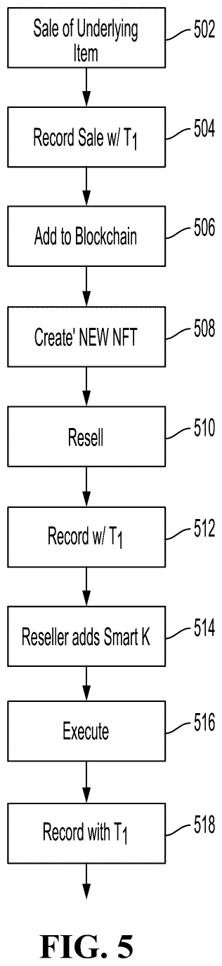

Reference is now made to FIG. 5 in which the method utilized by system 200 for tracking a lifecycle of the product is provided. The sale of the underlying item, watch 100, associated with the NFT is made in a step 502. The sale is recorded in step 504 by tracker T 206. The information regarding the sale, such as sales price, date, new owner, place of purchase, or the like is added to the blockchain associated with watch 100 by tracker 206 in a step 506. For example, the information may be associated with a purchase at Wimbledon, at a certain time, as described herein.

In a step 508, a new NFT, associated with watch 100 by the watch's blockchain is created by tracker T 206. The new NFT may be the previous NFT changed slightly, such as in color, to indicate a life stage of the watch 100. It may be a new NFT created as a function of information contained in, or associated with, the blockchain of either the cyber label or the NFT.

When watch 100 is resold in step 510, then the sale is reported to tracker T 206 to be recorded in database 208 in a step 512. As a result of the use of the NFT and the associated blockchain, the buyer is incentivized to record the transaction as a confirmation of authenticity and to preserve the value of both the item, watch 100, and the associated NFT. Optionally, the buyer and/or seller may allow system 200 to create a new NFT to reflect the new status or maintain the original NFT.

As a result of the cyber labeled use of the blockchain and NFT associated with watch 100, information about watch 100, both original and added, follows watch 100. Sellers add information such as purchase and sale information as discussed above. As discussed above one type of information may be a contract of sale such as a smart contract. The smart contract may have terms for downstream revenue sharing with the original creators of the intellectual property rights (patent, copyright, trademark) embedded in watch 100 with each proceeding owner and the provide U 216 of the unique value add component.

In a step 514 the reseller adds a smart contract which is electronically executed by the buyer in a step 516 as a condition of sale. The terms of the smart contract are recorded in a step 518 with tracker T 206 for recording in database 208 to become part of the information associated with the blockchain of the cyber label and/or NFT.

With fee sharing type clauses, the funds during the purchase are transmitted to a third party, such as tracker T 206 in a step 520 in this example. In a step 522 tracker T 206 arranges for payment to itself, the seller/reseller C 212 or M 210, dependent on the terms of the contract. In some embodiments, U 216 may be an artist whose artwork forms the basis for the NFT, an athlete who endorses watch 100, or Wimbledon, the venue associated with watch 100. In a step 524 tracker T 206 creates a new NFT to indicate the current status of watch 100 and is added to the blockchain associated with watch 100. Pursuant to a new smart contract, Wimbledon, the venue may now be entitled to a royalty payment. Steps 512-524 are repeated for each subsequent sale.

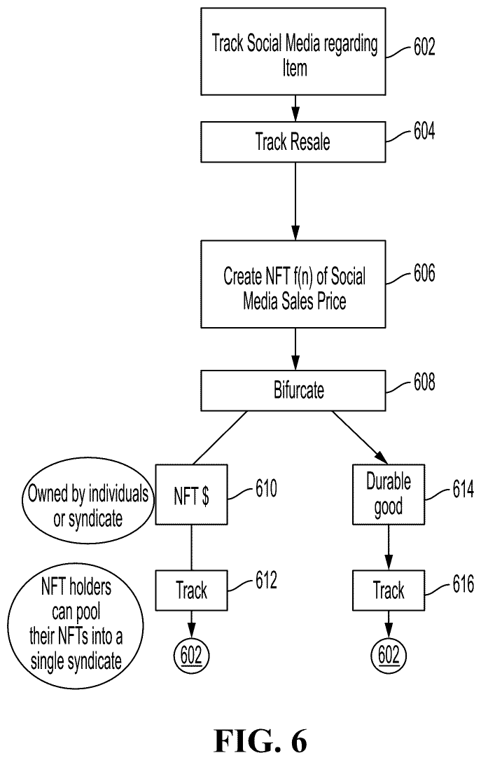

Many goods, such as watches, have value not only in their use, but as a collectable show piece as well. The same is true of NFTs. Therefore it may be in the interest of the downstream purchaser to decouple the NFT from the watch 100 to maximize the overly value. It should be understood that the NFT associated with a durable good such as a watch 100 may obtain intrinsic and monetary value apart from the durable good watch 100, or the like with which it was originally associated. The NFT itself may become a collectible, particularly if it takes the form of unique identifier form a celebrity or an artwork or one of a kind logo. Reference is now made to FIG. 6 in which a method for bifurcating the value of the NFT and its associated good is provided.

In a step 602 the owner of watch 100 and associated NFT monitors social media and other outlets regarding watch 100. As known in the art a product owner may monitor on line influencers for product mentions, Facebook® posts, retweets, shares associate therewith or other on line member platforms to not only determine mentions, but buzzwords indicative of sentiment. This monitoring may also include monitoring Meta data. Monitored metadata may be compared to known influencers' recognition of the product. Different inputs may be weighed differently so that one source or influencer does not overly skew the results.

In a step 604, a current owner tracks resale value by monitoring sales as recorded for similar watches 100. Tracking will include sales price, buy may also account for where sold as a function of geographical area, growth of the geographical area, the nature of the population: urban versus suburban.

In a step 606, if an owner has proven to themselves that there is sufficient value in the product, and more importantly an aftermarket, then tracker T 206 creates an NFT as a function of the social media response. The new token may be a version of the original NFT, but have a different color to show rising value, or a third color to show falling value, or it may be an independent FNT linked to the cyber label but having its own intrinsic value. In step 608 a product owner decouples the product from the NFT.

In a step 610, the owner of the NFT offers the NFT for sale. Utilizing the blockchain associated with the NFT ownership is now tracked for the NFT in a step 612. The new owner would then monitor social media and like sales to determine the value of the NFT. Similarly, the watch still has value apart from the NFT and can be resold in a step 614 as a collectable or in the normal stream of commerce. The new owner would then track the value of the watch in a step 616.

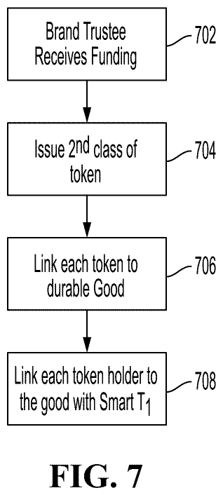

It is possible to reduce the financial risk of manufacture by raising funds ahead of manufacture utilizing a second class of token associated with the durable good. As seen in FIG. 7 in a step 702 manufacturer M₁ 210 creates a trustee such as tracker T 206 to track funding received from parties interested in funding the proposed project. In a step 704 Tracker T 206 issues the second class of token, linked, in step 706, to the to be manufactured good, or even the intellectual property right associated with the good, such as brand, construct or the like to each funder. The token may be a fungible good like a blockchain based limited currency or an NFT.

In a step 708 each token is linked to a smart contract. Because tracker T 206 tracks the durable good across its lifetime, as a result of each sale and NFT change being recorded, at least one clause of the smart contract is for each holder of a token from the second class of tokens to receive a portion of any sales proceeds associated with the goods. The clause applies to any sale of the good downstream; the token and the rights represented thereby follows the good.

As a result of the operation of tracker T 206 the token will have a value apart from the durable good, and may be sold along with its right to the smart contract. The smart contract may provide for downstream share in the proceeds for the token holder, the manufacturer M₁ 210, and any IP rights holder 216 in the durable good, maximizing a return on the manufacturing investment of each party while spreading the risk.

The above descriptions were made with the exemplary embodiment of the watch. However, the invention can be applied to clothing such as sneakers, shirts, particularly t-shirts associated with specific events, cares or the like.

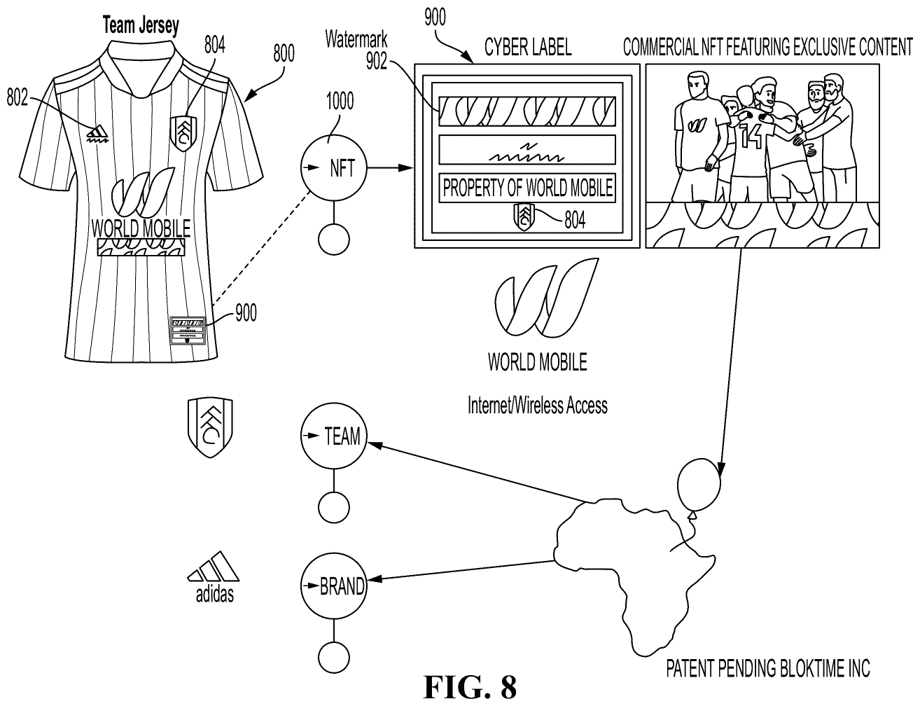

Reference is now made to FIG. 8 in which a manufactured product, such as a team jersey 800 is provided. Jersey 800 may include a sponsor or manufacturer logo 802 and team symbol 804. An encrypted cyber label 900 is also placed on the jersey 800. The cyber label 900 includes a watermark 902 and other information of authenticity, but acts as an optical code to link to an NFT 1000 associated by a blockchain with eh final product as discussed above. NFT durable good, and may be sold along with its right to the smart contract. The smart contract may provide for downstream share in the proceeds for the token holder, the manufacturer M₁ 210, and any IP rights holder 216 in the durable good, maximizing a return on the manufacturing investment of each party while spreading the risk.

The above descriptions were made with the exemplary embodiment of the watch. However, the invention can be applied to clothing such as sneakers, shirts, particularly t-shirts associated with specific events, cars or the like.

Reference is now made to FIG. 8 in which a manufactured product, such as a team jersey 800 is provided. Jersey 800 may include a sponsor or manufacture logo 802 and team symbol 804. An encrypted cyber label 900 is also placed on the jersey 800. The cyber label 900 includes a watermark 902 and other information of authenticity, but acts as an optical code to link to an NFT 1000 associated by a blockchain with the final product as discussed above. NFT 1000 may be the key (linked) to a unique image or video. NFT 1000 may also be linked by the blockchain to a smart contract causing some of the purchase funds for jersey 800 to be sent to the team as the license holder, back to the manufacturer as a realty, to investors as discussed below, or trigger an airdrop to a charity such as supporting cyber connectivity in rural nations.

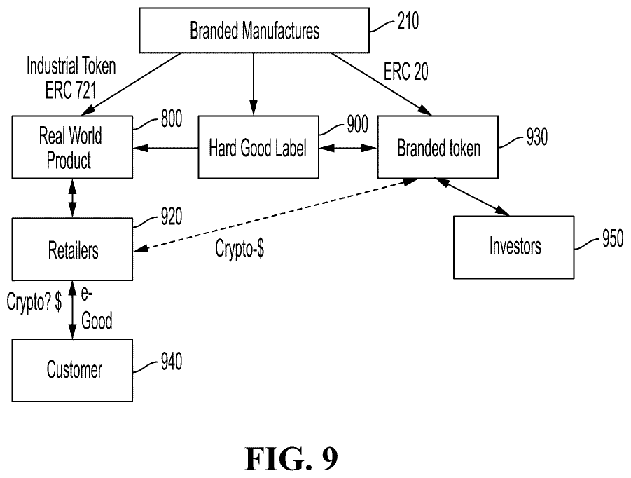

Reference is now made to FIG. 9 in which a system for utilizing an NFT in accordance with the invention is provided. As described above a branded manufacturer 210 creates a real world hard product such as jersey 800 by way of non-limiting example. Furthermore, as described above, an industrial NFT is created and associated with real world product 800. In some embodiments, the token is created in accordance with the ERC 721 protocol and is also linked to the hard good cyber label 900 associated with jersey 800.

A branded token 930 having the brand of branded manufacturer 210 is created and has the same brand the branded manufacturer. Investors 950 invest in branded tokens 930 with real currency such as dollars or with other cryptocurrency. A smart contract associated with NFT 1000 and linked to jersey 800 by the blockchain associated with NFT 1000 and by cyber label 900 causes a portion of sales of jersey 800 to be paid to branded manufacturer 210 and investors 950 in branded fungible tokens.

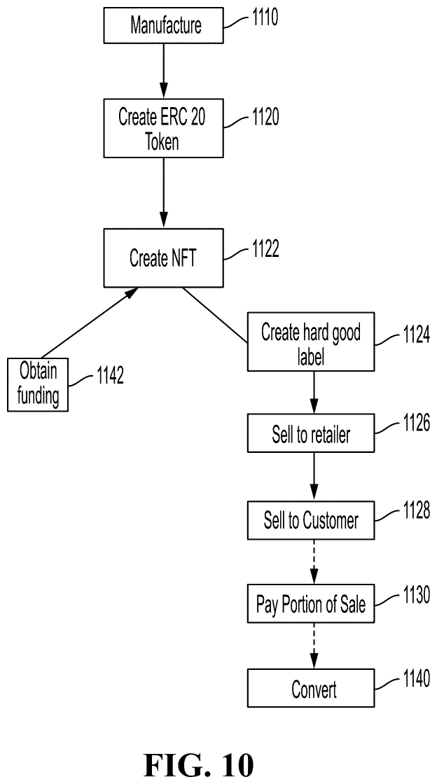

Reference is now made to FIG. 10 in which a process for utilizing privately branded tokens is provided. In a step 1110 branded manufacturer 210 creates a private labeled (branded) crypto currency 930. At the same time, or asynchronously, manufacturer 210 creates an NFT 1000 to be associated with a manufactured good 800 in a step 1122 and with a smart contract controlling future sales. In a step 1124 manufacturer 210 creates a cyber label 900 to be placed on manufactured good 800; the cyber label 900 having a machine readable watermark 900, or other machine readable link, to NFT 1000.

In a step 1126 the labeled good 800 and its associated cyber label 900 is old to a retailer 920. As a result NFT 1000 travels with good, unless the NFT is sold separately as discussed above. The sale may be in currency or in branded tokens. In a step 1128 the labeled good is sold to a customer in a step 1128. Customer is required to purchase the goods in branded tokens, a portion of which are paid back to branded manufacturer 210 in a step 1130 and/or to unique source 216 as discussed above.

The branded tokens are issued to the general public by manufacturer 210. In this way, there is some liquidity in the branded tokens, and the public at large is able to use the branded tokens to purchase the goods. The use of branded tokens also enables manufacturer 210 to reduce the product launch risk by raising funds by selling branded cryptocurrency to an investor pool in a step 1142. This enables investors to invest in the branded cryptocurrency as an asset. Additionally, in step 1142 the investor pool may be entitled to funds from after sale of the cyber labeled product pursuant to a smart contract linked to NFT 1000 linked to goods 800. The payment would be in branded cryptocurrency. This gives rise to a potential return on investment as the value of the branded crypto currency rises and form the income streams from sales of the goods 800 under the smart contracts with manufacturer 210.

Such a payment, as with many cryptocurrencies, is that it is relatively liquid. It may be hard to “cash out”. One must find a buyer willing to buy a seller's branded cryptocurrency in dollars. To increase potential liquidity, in a step 1140, the branded cryptocurrency is directly converted into a second branded cryptocurrency tied to goods as above. This is accomplished by establishing an exchange rate as a function goodwill in the branded cryptocurrency.

While the value of some crypto currencies such a Bitcoin or Ethereum have dollar values, branded cryptocurrencies which only have value for specified goods may not have a ready market. Therefore, their value may be determined as a function of the retail sale price of the good 800 less the cost to the retailer 920 of the good 800. It can be attributed to the value of the associated intellectual property and/or goodwill.

As a result of the above described system and method, it becomes possible to associate an NFT with a real world object. Furthermore, the NFT can change from one form to another, through updating or replacement, as lifecycle events occur. This can be “prenatal”, during manufacture, to post birth as the product changes ownership hands. The NFT starts to change to reflect each life step of the NFT and associated product as discussed above. The system and method above enable non-fungible tokens to be issued as a function of consumer sentiment as well as lifecycle transitions.

By utilizing the tracker to track information associated with each lifecycle stage and using blockchain to track these lifecycle events, ensures that the value of both the product and the NFT are secured for the life of the product. Additionally, cybersecurity is provided utilizing the private key encrypted in the watermark to form the cyber label. This provides protected access to biometrics, special information (geography), venue and event, product manufacture data, social media data, supply chain data, and other data analytics linked to the watch and NFT by the tracker in the system.

The system and method enable product owners to leverage analytics as a function of the information sorted by the tracker to create derivatives of the products based on market appreciation and unique market dynamics for the NFT both joined with the underlying product and apart from the underlying product. As a result, real world assets are also provided with a synthetic asset, the NFT, which has value apart from and separate from the value of the underlying real world asset. In accordance with the invention, the two may be decoupled from each other.

In summary, as a result of the inventive linking of the cyber label and NFT, any seller of a product that wants to be assured of its authenticity or any buyer that wants to know that what is being bought is authentic can be assured by the interaction of the cyber label and NFT as described above. In addition, through the use of blockchained information accessible through the cyber label, the creator of an object or unique intellectual property contributed to the product or associated NFT can participate in a percentage of any subsequent sales because of the tracked and blockchained sales transactions. The coupling of the cyber label and NFT permits “digitization” of physical products. Lastly, by utilizing cyber labeling each object and keeping a blockchained ledger of both the product and associated NFT the accurate and timely complete price history for unique and or expensive product and/or associate NFTs will provide unique insights for brands and consumers.

The above discussion is meant to be illustrative of the principles and various embodiments of the present disclosure. Numerous variations and modifications will become apparent to those skilled in the art once the above disclosure is fully appreciated. It is intended that the following claims be interpreted to embrace all such variations and modifications.

The word “example” is used herein to mean serving as an example, instance, or illustration. Any aspect or design described herein as “example” is not necessarily to be construed as preferred or advantageous over other aspects or designs. Rather, use of the word “example” is intended to present concepts in a concrete fashion. As used in this application, the term “or” is intended to mean an inclusive “or” rather than an exclusive “or.” That is, unless specified otherwise, or clear from context, “X includes A or B” is intended to mean any of the natural inclusive permutations. That is, if X includes A; X includes B; or X includes both A and B, then “X includes A or B” is satisfied under any of the foregoing instances. In addition, the articles “a” and “an” as used in this application and the appended claims should generally be construed to mean “one or more” unless specified otherwise or clear from context to be directed to a singular form. Moreover, use of the term “an implementation” or “one implementation” throughout is not intended to mean the same embodiment or implementation unless described as such.

Implementations the systems, algorithms, methods, instructions, etc., described herein can be realized in hardware, software, or any combination thereof. The hardware can include, for example, computers, intellectual property (IP) cores, application-specific integrated circuits (ASICs), programmable logic arrays, optical processors, programmable logic controllers, microcode, microcontrollers, servers, microprocessors, digital signal processors, or any other suitable circuit. In the claims, the term “processor” should be understood as encompassing any of the foregoing hardware, either singly or in combination. The terms “signal” and “data” are used interchangeably.

As used herein, the term module can include a packaged functional hardware unit designed for use with other components, a set of instructions executable by a controller (e.g., a processor executing software or firmware), processing circuitry configured to perform a particular function, and a self-contained hardware or software component that interfaces with a larger system. For example, a module can include an application specific integrated circuit (ASIC), a Field Programmable Gate Array (FPGA), a circuit, digital logic circuit, an analog circuit, a combination of discrete circuits, gates, and other types of hardware or combination thereof. In other embodiments, a module can include memory that stores instructions executable by a controller to implement a feature of the module.

Further, in one aspect, for example, systems described herein can be implemented using a general-purpose computer or general-purpose processor with a computer program that, when executed, carries out any of the respective methods, algorithms, and/or instructions described herein. In addition, or alternatively, for example, a special purpose computer/processor can be utilized which can contain other hardware for carrying out any of the methods, algorithms, or instructions described herein.

Further, all or a portion of implementations of the present disclosure can take the form of a computer program product accessible from, for example, a computer-usable or computer-readable medium. A computer-usable or computer-readable medium can be any device that can, for example, tangibly contain, store, communicate, or transport the program for use by or in connection with any processor. The medium can be, for example, an electronic, magnetic, optical, electromagnetic, or a semiconductor device. Other suitable mediums are also available.

The above-described embodiments, implementations, and aspects have been described in order to allow easy understanding of the present disclosure and do not limit the present disclosure. On the contrary, the disclosure is intended to cover various modifications and equivalent arrangements included within the scope of the appended claims, which scope is to be accorded the broadest interpretation to encompass all such modifications and equivalent structure as is permitted under the law.

What is claimed is:

1. A system for tracking a product comprising:
a processor; and
a memory including instruction that, when executed by the processor, cause the processor to:
receive a first blockchain associated with a first component product of a first supplier accessed through an encrypted cyber label;
receive a first non-fungible token operatively linked with the first component product and the first blockchain;
receive a second blockchain associated with a second component product of a second supplier accessed through a second encrypted cyber label;
receive a second non-fungible token operatively linked with the second component and first the first blockchain; and
generate a third blockchain operatively linked to a product manufactured based on at least the first component product and the second component product accessed through a third encrypted cyber label, the third blockchain including the first blockchain and the second blockchain, and a non-fungible token associated with the third blockchain, the non-fungible token having an encrypted private key which comprises at least a portion of the third blockchain.

2. The system of claim 1, wherein the non-fungible token is associated a unique product associated with a unique source.

3. The system of claim 1, wherein the instructions further cause the processor to track each sale of the product and information associated with each sale.

4. The system of claim 3, wherein the instructions further cause the processor to generate an updated non-fungible token as a function of at least the third blockchain, the non-fungible token, and the information associated with at least one sale.

5. The system of claim 4, wherein the instructions further cause the processor to receive funds from the at least one sale of the product.

6. The system of claim 5, wherein the instructions further cause the processor to distribute the funds among at least one of a manufacturer, a unique source, and a seller.

7. The system of claim 6, wherein the instructions further cause the processor to issue a first class of blockchain based tokens.

8. The system of claim 7, wherein each token is associated with a yet to be manufactured product.

9. The system of claim 7, wherein each token is associated with a smart contract associated with the first class of blockchain based tokens.

10. The system of claim 9, wherein a clause of the smart contract entitles an owner of a first class non-fungible token from the first class of blockchain based tokens use at least one durable goods.

11. A method for tracking a product comprising:
receiving a first blockchain associated with a first component product of a first supplier accessed through an encrypted cyber label;
receiving a first non-fungible token operatively linked with the first component product and the first blockchain;
receiving a second blockchain associated with a second component product of a second supplier accessed through a second encrypted cyber label;
receiving a second non-fungible token operatively linked with the second component and first the first blockchain; and
generating a third blockchain operatively linked to a product manufactured based on at least the first component product and the second component product accessed through a third encrypted cyber label, the third blockchain including the first blockchain and the second blockchain, and a non-fungible token associated with the third blockchain, the non-fungible token having an encrypted private key which comprises at least a portion of the third blockchain.

12. The method of claim 11, wherein the non-fungible token is associated a unique product associated with a unique source.

13. The method of claim 11, further comprising tracking each sale of the product and information associated with each sale.

14. The method of claim 13, further comprising generating an updated non-fungible token as a function of at least the third blockchain, the non-fungible token, and the information associated with at least one sale.

15. The method of claim 14, further comprising receiving funds from the at least one sale of the product.

16. The method of claim 15, further comprising distributing the funds among at least one of a manufacturer, a unique source, and a seller.

17. The method of claim 16, further comprising issuing a first class of blockchain based tokens.

18. The method of claim 17, wherein each token is associated with a yet to be manufactured product.

19. The method of claim 17, wherein each token is associated with a smart contract associated with the first class of blockchain based tokens.

20. The method of claim 19, wherein a clause of the smart contract entitles an owner of a first class non-fungible token from the first class of blockchain based tokens use at least one durable goods.
